(19) United States
(12) Patent Application Publication
(10) Pub. No.: US 2009/0069047 A1
(43) Pub. Date: Mar. 12, 2009

(54) Methods, systems, and computer program products for detecting wireless bypass in a communications network

(75) Inventors: Travis E. Russell, Clayton, NC (US); Peter J. Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Tekelec

(21) Appl. No.: 11/978,537

(22) Filed: Oct. 29, 2007

Related U.S. Application Data
(60) Provisional application No. 60/967,808, filed on Sep. 7, 2007.

(51) Int. Cl. H04M 1/00

(52) U.S. Cl. 455/558

(57) ABSTRACT

Methods, systems, and computer program products for detecting wireless bypass in a communications network is described. In one embodiment, the method includes analyzing at least one of wireless signaling message traffic in a wireless communications network, financial information regarding wireless communications network subscriptions, and subscriber records maintained in the wireless communications network. The method also includes determining, based on the analysis, whether a wireless bypass signature is indicated. In response to determining that a wireless bypass signature is indicated, a mitigating action is performed.

### RELATED APPLICATIONS

The present application claims the benefit of U.S. Provisional Patent Application Ser. No. 60/967,808, filed Sep. 7, 2007, incorporated herein by reference in its entirety.

### TECHNICAL FIELD

The subject matter described herein relates to the monitoring of wireless bypass traffic events occurring in a communications network. More particularly, the subject matter described herein relates to methods, systems, and computer program products for detecting wireless bypass in a communications network.

### BACKGROUND

Wireless bypass refers to the use of a subscriber identity module (SIM) box or other equivalent device to make calls that originate or terminate with out of network subscribers appear as in-network calls for preferential billing. Wireless service providers often provide preferential billing for mobile calls that originate and terminate between their subscribers. SIM boxes are devices that appear to a wireless network as multiple handsets. They have authorized uses, such as terminating calls between different corporate sites.

SIM boxes also have unauthorized uses. One unauthorized use of a SIM box is wireless bypass. In one wireless bypass scenario, a wireless bypass provider may market international calling at a discounted rate over rates provided by network operators. The wireless bypass provider may provide an access number for customers to access the discount international calling service. The customer dials the access number and enters the called party number. The call may be routed over a voice over Internet Protocol (VoIP) network through a SIM box in the called party's network to make the call appear as an in-network call. The call will thus receive a preferred rate. The SIM card used in a SIM box may be prepaid SIM cards because they can be anonymously purchased and recharged.

One problem with this and other wireless bypass scenarios is that wireless bypass calls utilize network resources that would be available for legitimate calls. If the volume of wireless bypass calls is large, legitimate calls can be precluded or can receive degraded service.

Accordingly, there exists a need for methods, systems, and computer program products for detecting wireless bypass in a wireless communications network.

### SUMMARY

The subject matter described herein includes methods, systems, and computer program products for detecting wireless bypass in a communications network. One method includes analyzing at least one of wireless signaling message traffic in a wireless communications network, financial information regarding wireless communications network subscriptions, and subscriber records maintained in the wireless communications network. The method also includes determining, based on the analysis, whether a wireless bypass signature is indicated. In response to determining that a wireless bypass signature is indicated, a mitigating action is performed.

The subject matter described herein for detecting wireless bypass may be implemented using a computer program product comprising computer executable instructions embodied in a tangible computer readable medium that are executed by a computer processor. Exemplary computer readable media suitable for implementing the subject matter described herein includes disk memory devices, programmable logic devices, and application specific integrated circuits. In one implementation, the computer readable medium may include a memory accessible by a processor. The memory may include instructions executable by the processor for implementing any of the methods for detecting wireless bypass described herein. In addition, a computer readable medium that implements the subject matter described herein may be distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a network diagram that illustrates a SIM box for facilitating wireless bypass in an exemplary communications network;

FIG. 2 is a network diagram that illustrates an intermediary wireless network for facilitating wireless bypass in an exemplary communications network;

FIG. 3 is a network diagram that illustrates a SIM box controller used to coordinate a plurality of SIM boxes in an exemplary communications network;

FIG. 4 is a network diagram illustrating a wireless bypass detection system utilizing probes for collecting signaling data according to an embodiment of the subject matter described herein;

FIG. 5 is a block diagram illustrating exemplary components of a wireless bypass detection system according to an embodiment of the subject matter described herein;

FIG. 6A is a network diagram illustrating a wireless bypass detection system utilizing a signal transfer point for collecting signaling data according to an embodiment of the subject matter described herein;

FIG. 6B is a block diagram of a signal transfer point containing an integrated wireless bypass detection module according to an embodiment of the subject matter described herein;

FIG. 7 is a flow chart illustrating exemplary steps for detecting wireless bypass according to an embodiment of the subject matter described herein;

FIG. 8 is a network diagram illustrating a wireless bypass detection system that redirects suspect calls to an IVR system according to an embodiment of the subject matter described herein; and

FIG. 9 is a network diagram illustrating a wireless bypass detection system utilizing a ping call generator and analyzer according to an embodiment of the subject matter described herein.

### DETAILED DESCRIPTION

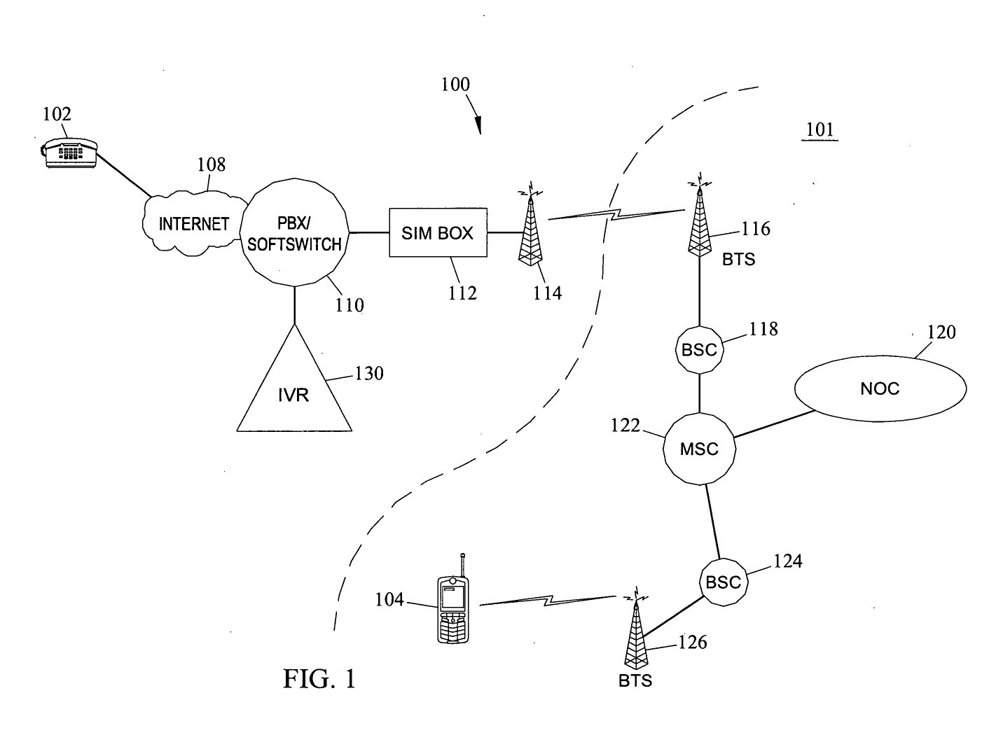

The present subject matter relates to systems, methods, and computer program products for detecting wireless bypass in a wireless communications network. In order to better understand the present subject matter, an explanation regarding the manner in which a wireless communications network may be exploited by wireless bypass will now be provided. FIG. 1 illustrates an exemplary telecommunications network 100 that includes a GSM (global system for mobile communications) gateway for facilitating bypass traffic in a wireless network 101. In one embodiment, the GSM gateway includes a subscriber identity module (SIM) box 112. As described above, SIM box 112 may be programmed with plural SIM cards and may have one or more radio interfaces for originating and terminating calls in a wireless network. The SIM cards that SIM box 112 is programmed with may have in-network IMSIs and MSISDN numbers so that calls originated and terminated by SIM box 112 in a wireless network will appear as in-network calls to the wireless network.

An exemplary wireless bypass event may begin at a wireline phone 102 initiating a call which is redirected to SIM box 112, which is operated by a reseller of long distance call services. Notably, SIM box 112 has a subscription (e.g., is provisioned with at least one SIM card that includes a prepaid subscription) to the same wireless network as the called party, e.g., mobile device 104. In one example, the call is routed as a voice-over-IP (VoIP) call over Internet network 108 and is terminated at a private branch exchange (PBX) 110, which is communicatively coupled to SIM box 112.

As described above, SIM box 112 may be programmed with multiple SIM cards and may include multiple antennas. In one embodiment, SIM box 112 is able to support GSM, GPRS, UMTS, and CDMA technologies and may interface with T1/E1, ISDN, and VoIP facilities. SIM box 112 is typically placed in proximity to a base transmission station (BTS), such as BTS 114, which is capable of communicating with the BTSs in network 101. Although SIM box 112 supports multiple SIM card subscriptions, wireless network 101 still recognizes SIM box 112 as a single device since SIM box 112 is assigned a single programmable international mobile equipment identity (IMEI), which is a unique number that designates SIM box 112 as a valid device in a GSM wireless network. In one embodiment, a reseller provisions SIM box 112 with a plurality of prepaid subscription SIM cards. Each SIM card is considered a subscription to the wireless network to which the SIM card is associated.

SIM box 112 is able to initiate and terminate mobile-to-mobile calls with any mobile device using one or more prepaid SIM cards that provides a subscription to network 101. Thus, SIM box 112 is capable of establishing calls in the same manner as any other mobile device belonging to a network. A reseller may use prepaid SIM cards since a prepaid subscription to a network may be registered anonymously and thereby reduce the chances the reseller may be identified. Specifically, using prepaid SIM cards enables a reseller to conceal his identity as opposed to registering a conventional subscription with the wireless service provider (e.g., the service provider of wireless network 101). Because of the high volume of calls typically serviced by the reseller, the prepaid SIM cards are typically “recharged” (i.e., re-provisioned with funds) several times a day as the subscription account becomes depleted. Furthermore, the prepaid cards are usually recharged with high balances in order to handle the number of calls serviced by the reseller. The prepaid SIM cards may also be recharged either in person with cash (thereby assuring anonymity) or over the Internet in a remote manner.

Returning to the discussion of a call originated by calling party 102, the call may initially be routed to IVR 130 via softswitch 110. IVR 130 collects the digits for called party 104. SIM box 112 uses the MSISDN provisioned for one of its subscriptions to re-originate the call as an in-network call to mobile device 104 over BTSs 114 and 116. From BTS 116, the call is ultimately routed to the called party's mobile device 104. By re-originating the call in this manner, a reseller provides a service that allows a subscriber to avoid long distance charges and out-of-network charges since SIM box 112 (i.e., at least one SIM card used by SIM box 112) is making calls as an in-network subscriber.

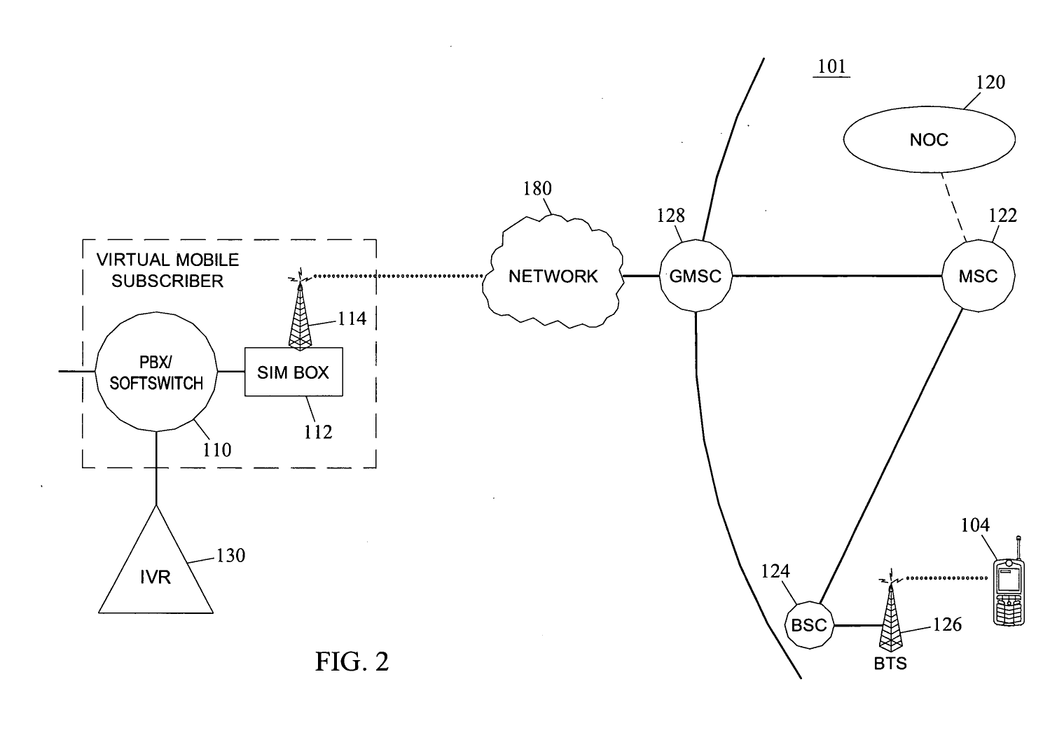

Although only one wireless network (i.e., network 101) is shown in FIG. 1, inbound SIM box calls may traverse one or more additional wireless networks before reaching the terminating wireless network. For example, FIG. 2 illustrates a wireless network 180 that may be used as a connecting network between SIM box 112 and target wireless network 101. This routing scheme may be intentionally used by a reseller in order to make it difficult for wireless network operators to detect the bypass traffic.

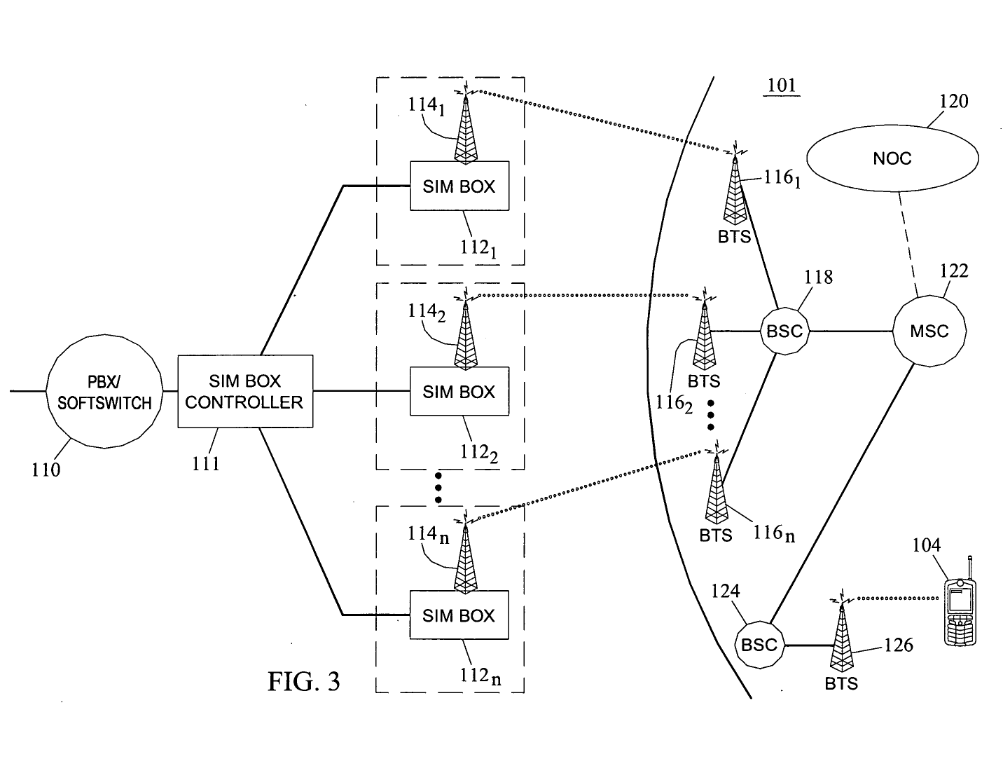

A reseller typically arranges for a SIM box 112 to be placed near a BTS tower for optimal communication and to avoid any difficulties and charges associated with roaming. In some instances, the reseller's SIM box may be detected by a network operator due to its stationary nature. To avoid this problem, a reseller may use several SIM boxes, each of which is located near a different BTS. In one instance, as shown in FIG. 3, a plurality of SIM boxes 112_{1 . . . n} are used in conjunction with a SIM controller 111. Notably, in this scenario, SIM box controller 111 receives the initial call signaling message from wireline phone 102. Either SIM box controller 111 or an IVR unit (not shown) prompts wireline phone 102 for the phone number the caller wishes to reach. In an effort to conceal its location, SIM box controller 111 may randomly select a SIM box 112 to re-originate the call to wireless network 101. By having multiple SIM boxes 112_{1 . . . n} positioned in different locations, the reseller is able to distribute the point where wireless bypass calls are re-originated instead of having a single point of access to network 101 that is responsible for an abnormally high number of phone calls (which may appear suspicious). Although additional SIM boxes also increase the reseller's service capability and potential revenue, this practice can quickly overburden wireless network 101 with the significant increase of “wireless” bypass calls.

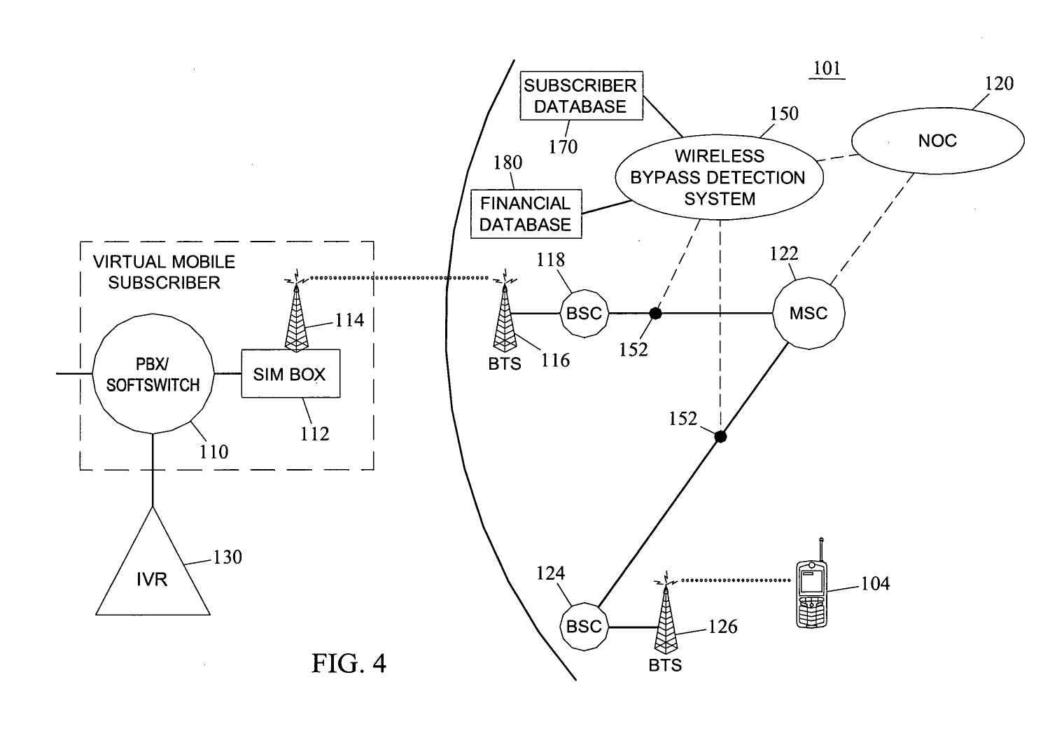

In order to detect wireless bypass events, the present subject matter may include a wireless bypass detection system (WBDS) 150. FIG. 4 depicts an exemplary WBDS 150 as a stand-alone component in customer network 101. In one embodiment, WBDS 150 is responsible for collecting signaling data from signaling messages traversing wireless network 101. The signaling data may be filtered and analyzed for call characteristics that may indicate wireless bypass events. The actual collection of call signaling data may be performed by WBDS 150 through the use of one or more probes 152 positioned within customer network 101. For example, WBDS 150 may include at least one probe 152 placed on each of the links that couple MSC 122 to BSC 118 and BSC 124. Probe 152 may copy signaling messages that traverse the link that it monitors.

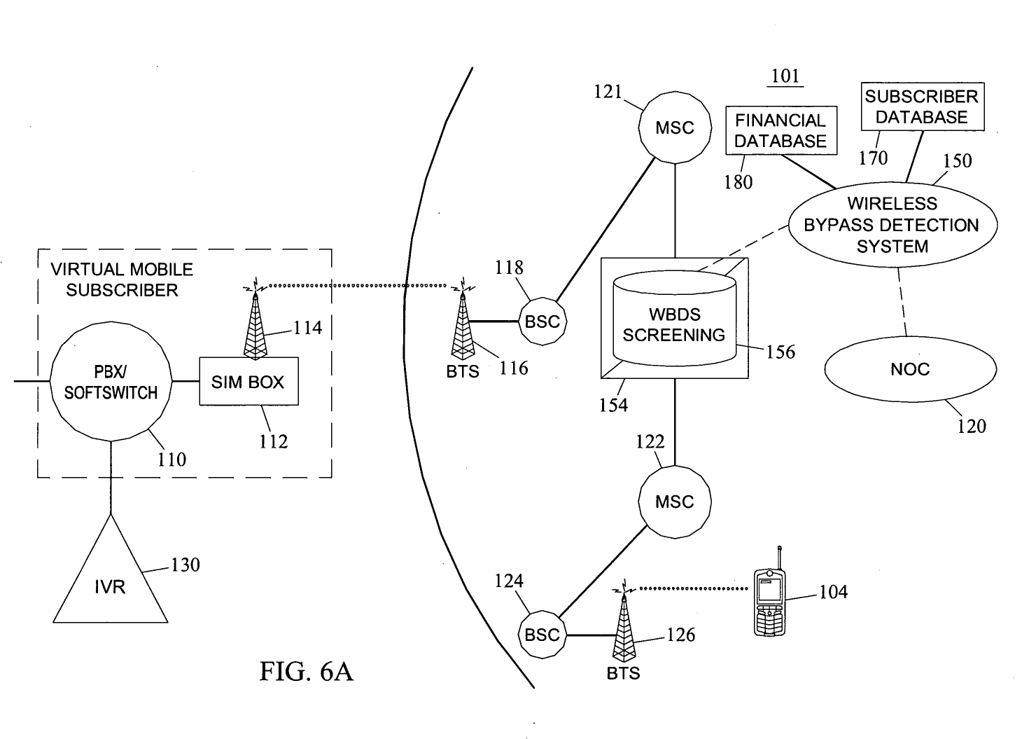

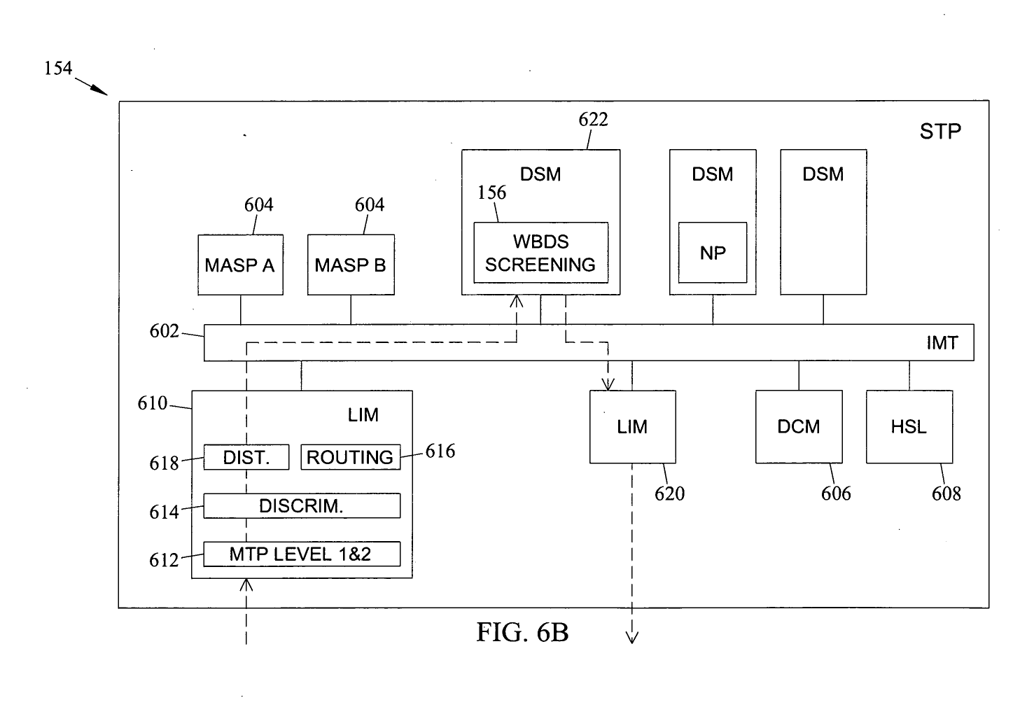

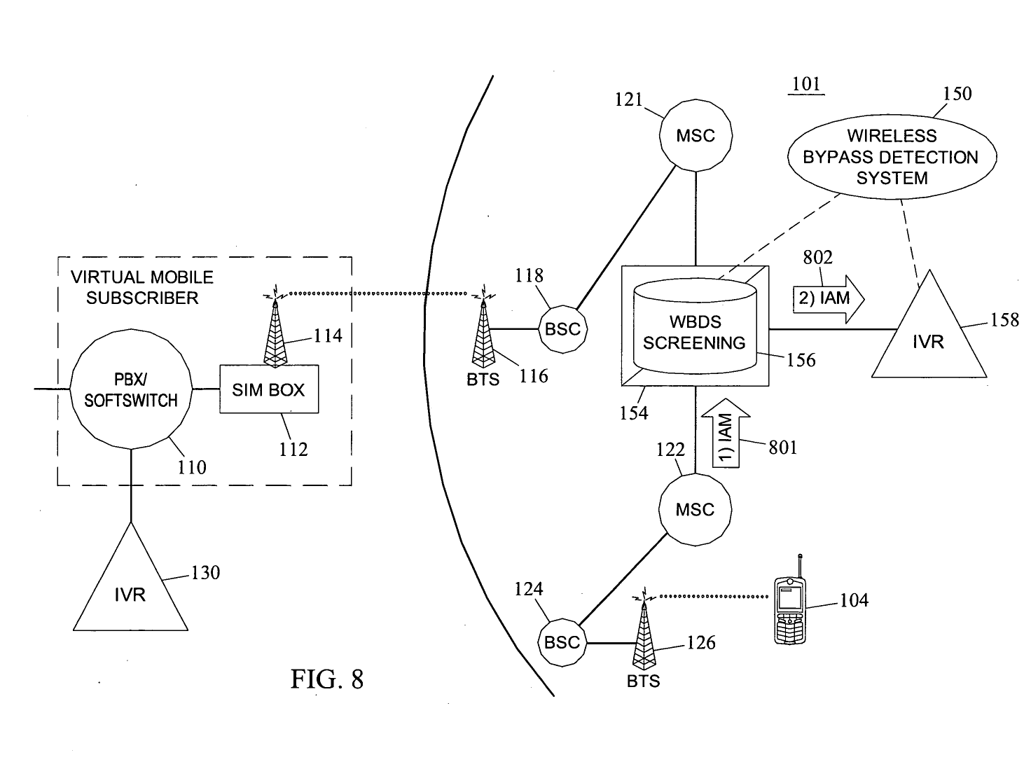

In one embodiment, probe 152 transparently copies the traversing signaling messages and forwards the copied messages to WBDS 150. In an alternate embodiment, WBDS 150 may be implemented as a component module within a network signaling node (as shown below in FIGS. 6 and 8), such as a signal transfer point (STP), instead of existing as a stand-alone network component.

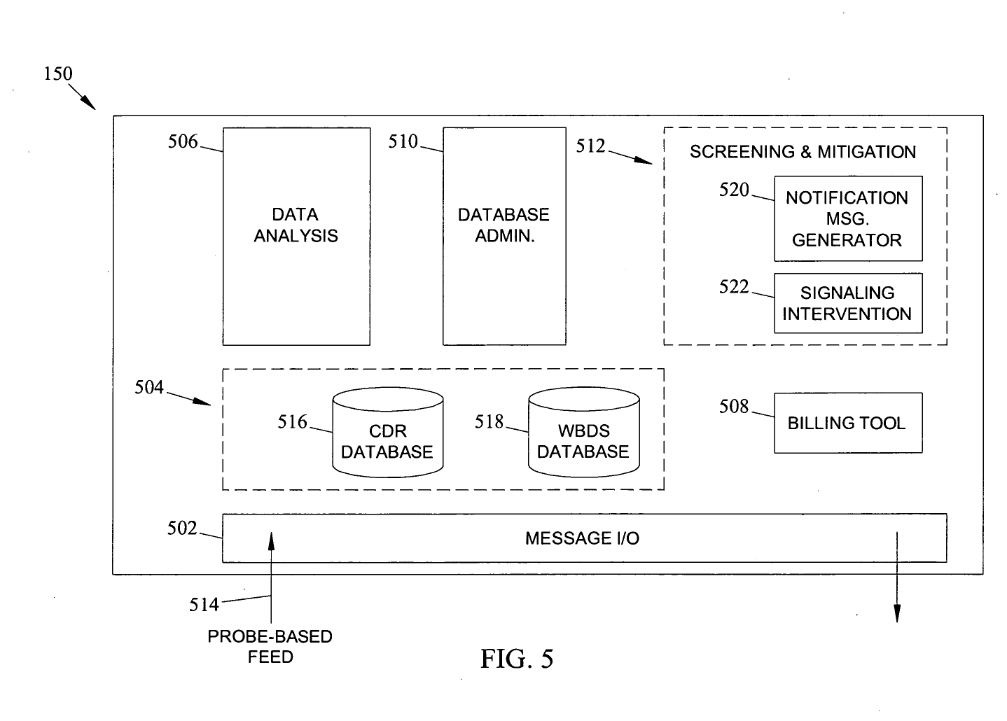

FIG. 5 is a block diagram of an exemplary wireless bypass detection system (WBDS) 150. Referring to FIG. 5, WBDS 150 includes a message input/output interface module 502, a database structure 504, a data analysis module 506, a billing module 508, a database administration module 510, and a wireless bypass event screening and mitigation module 512. In one embodiment, message I/O interface module 502 may be adapted to receive call signaling data via a probe based feed 514. Wireless bypass event screening and mitigation module 512 may utilize filters for detecting certain wireless bypass traffic characteristics based on signaling messages received via probe-based feed 514 or based on data in CDR database 516. In one embodiment, the filters are stored in a WBDS database 518. CDR database 516 stores a plurality of CDRs generated based on call signaling messages. WBDS database 508 stores various call characteristics and threshold values that are used to create a filter to be used by WBDS 150. Data analysis module 506 may facilitate analysis of signaling message data received via probe based feed 514 or in CDR database 516. For example, data analysis module 506 may parse signaling message data for signaling message parameters requested by screening and mitigation function 512. Database administration module 512 may be used to modify any threshold based characteristics stored in WBDS database 518. If a wireless bypass event is detected with a filter, wireless bypass event screening and mitigation component 512 may use signaling intervention module 522 to perform a mitigating action, such as blocking future calls (in a mobile originated call scenario) to a SIM box suspected of facilitating bypass traffic. Bypass traffic event screening and mitigation module 512 may also include a notification message generator module 520 to alert a customer network operator or network operator center (NOC) (e.g., NOC 120 in FIG. 4) of the detected bypass traffic. The network operator may then perform any additional analysis and/or any mitigating action.

In an alternate embodiment, bypass traffic event screening and mitigation module 512 may be implemented as a WBDS screening module 156 within STP 154 as shown in FIG. 6A. WBDS screening module 156 may be adapted to collect (and/or copy) call signaling messages that traverse a given signaling link and forward the messages to WBDS 150. Although only one gateway STP 154 is shown in FIG. 6A, additional STPs may be utilized in customer network 101 without departing from the scope of the present invention

FIG. 6B is a block diagram of an exemplary internal architecture of a signaling message routing node, such as STP 154, with an integrated WBDS screening module 156 according to an embodiment of the subject matter described herein. Referring to FIG. 6B, WBDS screening module 156 may be located at STP 154, which includes an internal communications bus 602 that includes two counter-rotating serial rings. In one embodiment, a plurality of processing modules or cards may be coupled to bus 602. In FIG. 6, bus 602 may be coupled to one or more communications modules, such as a link interface module (LIM) 610, a data communications module (DCM) 606, a database service module (DSM) 622, a high speed link (HSL) 608 and the like. Each of these modules is physically connected to bus 602 such that signaling and other types of messages may be routed internally between active cards or modules. LIM 610 includes functionality for sending and receiving SS7 messages via an SS7 network. DCM 606 includes functionality for sending and receiving SS7 messages over IP signaling links. Similarly, HSL 608 includes functionality for sending and receiving messages over a high speed link.

When a signaling message is received by STP 154, the message may be processed by LIM 610, DCM 606, or HSL 608 depending on whether the message is sent over an SS7 link, an IP signaling link, or a high speed link. The message is passed up the communications protocol stack on the receiving communication module until it reaches the module's respective message distribution function, which forwards the call signaling message to DSM 622. In one embodiment, at least one DSM module 622 in STP 154 is equipped with a WBDS screening module. In one embodiment, WBDS screening module 156 functions in a similar manner to the screening and mitigation module 522 depicted and described in FIG. 5. Notably, instead of being equipped with probe-based feed 515, WBDS screening module 156 (in FIG. 6) receives call signaling messages from DSM, LIM, and HSL modules (which are respectively coupled to a signaling link entering STP 154). That is, in one implementation, call signaling messages received by LIM 610 or 620, and DCM 606, or HSL 608 may be screened at the receiving module and identified as candidates for WBDS processing. For example, ISUP messages or SIP messages associated with call setup and teardown may be identified as WBDS screening candidates and forwarded to WBDS 150 for processing. In an alternate implementation, LIM 610, LIM 620, DCM 606, and HSL 608 may each include a message copy function that copies all received signaling messages and sends the copies to WBDS screening module 156 for screening or that selectively copies candidate messages for screening and sends the candidates to WBDS screening module 156.

After collecting signaling data from wireless network 101, WBDS 150 is adapted to analyze the data by inspecting for specific parameters, such as bypass traffic signatures. In one embodiment, WBDS 150 is configured to monitor the collected signaling data for a number of signatures that may indicate a bypass traffic event. In one embodiment, WBDS 150 may employ one or more filters to screen the signaling message traffic to identify the bypass traffic signatures.

In one embodiment, a filter may be designed to recognize one or more wireless bypass signatures. For example, a filter may be used to determine if a subscription (e.g., a prepaid SIM card subscription) fails to roam. Notably, a subscription that does not roam may indicate that a SIM box is servicing bypass traffic. Similarly, a filter may be configured to detect a signature involving a subscription that appears to roam within the network but does so in a semi-fixed pattern. The semi-fixed pattern may include a calling pattern that appears to originate from the same cell sites all the time with little or no deviation.

Another wireless bypass signature that may be monitored for WBDS 150 includes a subscription that always initiates calls but rarely (or never) receives them. SIM boxes are primarily used for making calls as opposed to receiving calls. In one embodiment, a filter may be used to detect a subscription that exhibits a very high call volume (e.g., above normal for most prepaid subscriptions). A high call volume from a given prepaid subscription may indicate a SIM box is being used. Another wireless bypass signature that may be detected by a filter includes a subscription that utilizes an IMEI known to be a SIM box or a GSM gateway that includes a SIM box. Yet another detectable wireless bypass signature may include a subscription that has a high call density. For example, a subscription that originates a call as soon as it releases a previous call may indicate the existence of a bypass traffic event. This may indicate a bypass traffic SIM box that services a call immediately after the previously serviced call releases.

Another wireless bypass signature that may be monitored via a filter includes a subscription that terminates calls to an extremely diverse group of seemingly unrelated mobile devices. Most subscribers have a common group of mobile numbers that are frequently called, such as mobile numbers belonging to friends and family members. However, a subscription related to a SIM box servicing bypass traffic is abnormal in this regard since it is servicing calls to an extremely diverse range of numbers (because a diverse group of callers are being serviced by the SIM box).

Another wireless bypass signature that may be monitored includes subscriptions characterized by calls with durations that are typically longer than normal. A wireless bypass call normally has a longer duration because a subscriber is typically more apt to talk for a longer period of time since the call is charged at a reduced rate. Yet another call bypass signature that may be monitored includes a subscription that does not activate other features or services such as voicemail or data services. Whereas most subscriber use various communication features, a subscription using a SIM box to service bypass traffic exclusively uses voice services since a reseller is only concerned with re-originating calls to wireless network 101.

If a predefined number of these exemplary signatures (or other signature types) are detected by the WBDS filters, then WBDS 150 may access and analyze other sources of information to confirm the bypass nature of the signaling data. In one embodiment, WBDS 150 obtains IMEI and/or MSISDN numbers from the bypass traffic during the filtering process or from collected call detail records (CDRs). Bypass traffic screening and mitigation module 622 may then use certain identification numbers, such as the IMEI number or MSISDN, which are associated with a suspected SIM box from the bypass signaling data to obtain certain financial and subscription data from databases 170 and 180 to verify that the suspected traffic is bypass traffic. In one embodiment, subscriber database 170 contains account information that includes a subscriber identification number, the type of calling device used, as well as other subscriber information. Financial database 180 may include a subscriber identification number, the type of subscription (e.g., prepaid or conventional), payment information, and the like. In one embodiment, WBDS 150 identifies an IMEI number, a TMSI (temporary mobile subscriber identity) number, a MSISDN (mobile subscriber ISDN) number, and an IMSI (international mobile subscriber identity) number from the signaling stream. Collectively, this information may be used to identify the type of device and subscription being used to access wireless network 101. For example, the TMSI/IMSI/MSISDN combination obtained from the collected data may be used to determine whether in-network access is being achieved through a prepaid-type subscription by cross-referencing subscription entries in subscriber database 170. In addition, data analysis module 514 may analyze the collected data to determine if a SIM box is being used to access the network by cross-referencing a suspected identification number (e.g., an IMEI number) with subscriber database 170.

WBDS 150 may also be configured to acquire financial information regarding wireless communications from financial database 180 in order to confirm a suspected source of bypass traffic. After obtaining information from the collected data, bypass traffic screening and mitigating module 522 may cross-reference subscription entries of financial database 180 with a suspected MSISDN or SIM number. For example, if an MSISDN or SIM subscription is associated with a prepaid account that is recharged with exceptionally high amounts, WBDS 150 may flag the MSISDN or SIM number as a wireless bypass service number. In one embodiment, this information may be obtained from event records associated with an IMEI or MSISDN from financial database 180. In addition, WBDS 150 may also be adapted to consider the frequency in which the prepaid subscriptions are recharged. Both signatures may be measured objectively by configuring a filter with predefined threshold (which may be adjusted by a network operator or NOC 120). In an alternate embodiment, databases 170 and 180 may be used by WBDS 150 as a means to detect a bypass event as opposed to being used for confirmation.

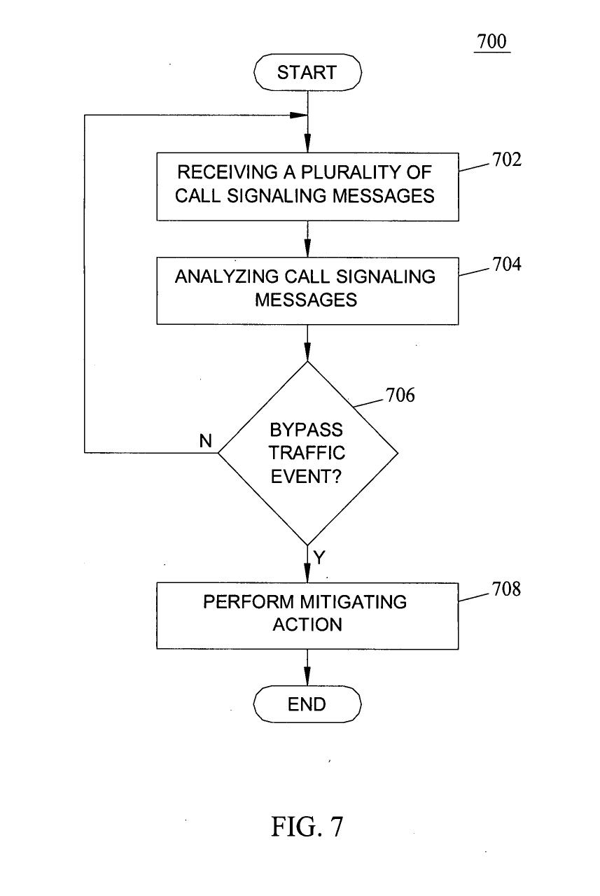

FIG. 7 illustrates a flow chart of an exemplary method 700 for detecting a bypass traffic event according to an embodiment of the subject matter described above. In one embodiment, method 700 may be executed by a processing unit, such as screening and mitigation module 522 in WBDS 150 or a like computer processing device. In block 702, a plurality of call signaling messages is received. In one embodiment, WBDS 150 utilizes at least one probe to capture call signaling messages entering (or leaving) MSC 122. In an alternate embodiment, a network signaling node, such as STP 154, is equipped with a WBDS screening module 156 that receives call signaling messages entering STP 154. More specifically, a communication module, such as LIM 610 receives call signaling messages from a signaling link and forwards the signaling messages to DSM 622. In one embodiment, a financial database 180 and a subscriber record database 170 may be accessed to obtain financial records and subscriber records, respectively.

In block 704, the call signaling messages are analyzed. In one embodiment, WBDS 150 utilizes a screening and mitigation module 522 to apply filters to the received call signaling messages. Specifically, screening and mitigation module 522 uses the filters in an attempt to detect various call signatures in the wireless signaling message traffic. Similarly, data analysis module 514 may also analyze financial information regarding wireless subscriptions and subscriber records from financial database 180 and subscriber database 170, respectively.

In block 706, a determination is made, based on the analysis, as to whether a bypass traffic event is detected. In one embodiment, data analysis module 514 analyzes the filter results to determine if a possible bypass traffic event exists. For example, if a predefined number of filter thresholds are exceeded, then a possible bypass traffic event is detected. If a possible bypass traffic event exists, then method 700 continues to block 708. If a bypass traffic event is not suspected, then method 700 loops back to block 702 to continue monitoring.

In block 708, a mitigating action is performed. In response to detecting a bypass traffic event, WBDS 150 may perform a mitigation action. In one embodiment, WBDS 150 is configured to alert a network operator of the bypass traffic event. For example, WBDS 150 may send an alarm message to NOC 120. The method 700 then ends.

As mentioned above, WBDS 150 may be configured to perform a mitigating action such as generating an alarm. For example, when a bypass traffic event occurs and is detected by WBDS 150 (or WBDS screening module 156), a network operator may receive an alarm at NOC 120 indicating the bypass traffic event is occurring. Upon receiving the alarm, the operator may analyze the filtered data to confirm the occurrence of the detected bypass traffic. The alarm may also identify the point of origination of the bypass traffic so that other mitigating actions may be performed.

In one embodiment, WBDS 150 monitors mobile originated outbound calls (either as a stand-alone network component or via WBDS screening module 156) and the associated called party digit information (collected via the network operated IVR 158). After sufficient information is gathered to identify the SIM numbers or MSISDNs suspected of being used for the wireless bypass traffic event, WBDS 150 may alarm NOC 120 or may intercept calls directed to the identified offending SIM numbers or MSISDNs. For example, FIG. 8 depicts a network diagram illustrating a wireless bypass detection system screening module that reroutes mobile originated calls originally directed to a suspected MSISDN or SIM number to an IVR system controlled by wireless network 101. In one embodiment, WBDS screening module 156 receives a call signaling message (e.g., IAM 401) that is directed to SIM box 112. In this particular scenario, WBDS 150 has previously designated the MSISDN or SIM number associated with SIM box 112 as a device suspected of conducting wireless bypass services. Provided with this information, WBDS screening module 156 redirects the suspect call signaling message (e.g., as IAM 402) to a network controlled IVR 158.

Upon receiving IAM 402, IVR 158 prompts the caller to enter the desired called party number (i.e., not unlike the manner in which normal prepaid calling card calls are initiated). The calling party, who is likely to be unaware that they are not in communication with an IVR associated with the bypass traffic service or SIM box 112, is likely to comply and enter the requested called party digit information. If the called party digit information corresponds to a number that differs from the originally dialed number (e.g., a number that differs from the SIM device number) a mitigating action may be performed. For example, the call may either be blocked (e.g., dropping the IAM or issuing a release message) or routed to the called party at out-of-network rates. The call may also be forwarded to NOC 120 for other mitigating actions.

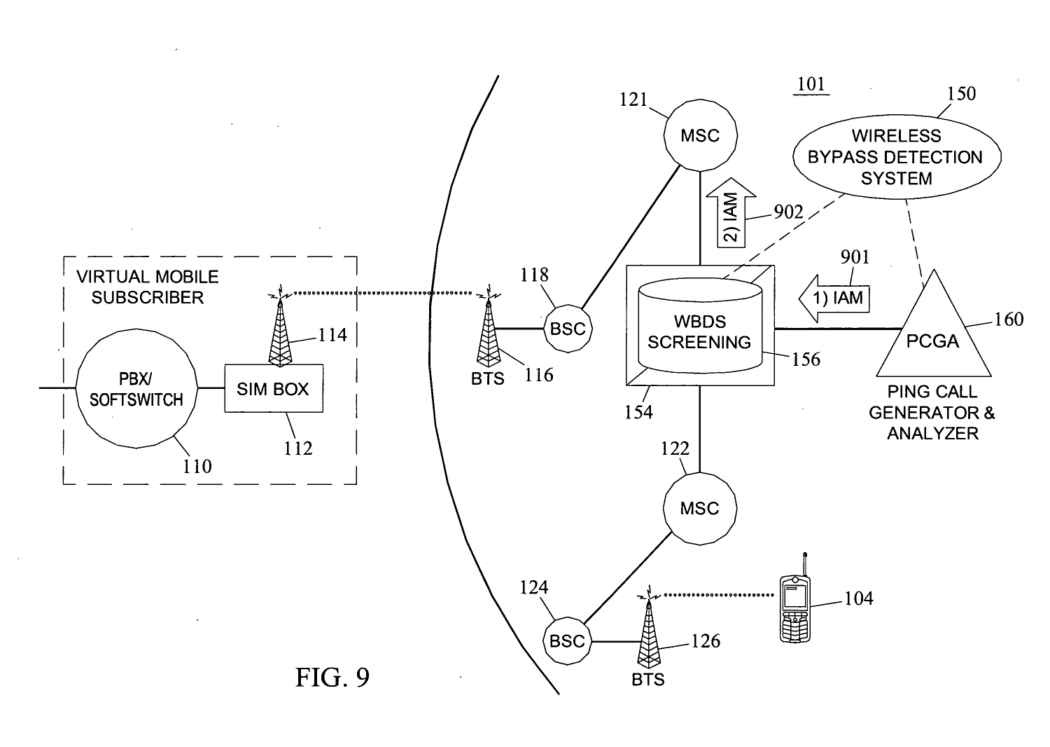

In another embodiment, a ping call confirmation system may be utilized in conjunction with WBDS 150. For example, FIG. 9 is a network diagram illustrating a wireless bypass detection system adapted to utilize a bypass traffic generator according to an embodiment of the subject matter described herein. In one embodiment, a ping call generator and analyzer (PCGA) system 160 places one or more call signaling messages to a MSISDN or SIM suspected of being associated with a wireless bypass service or SIM box 112. If the ping call is answered, but a voice is not detected on the called party line, then there is a high probability that the MSISDN is associated with wireless bypass service or SIM box device. PCGA 160 subsequently records this confirmation information.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for detecting wireless bypass in a communications system, the method comprising:
(a) analyzing at least one of:
(i) wireless signaling message traffic in a wireless communications network;
(ii) financial information regarding wireless communications network subscriptions; and
(iii) subscriber records maintained in the wireless communications network;
(b) determining, based on the analysis, whether a wireless bypass signature is indicated; and
(c) in response to determining that a wireless bypass signature is indicated, performing a mitigating action.

2. The method of claim 1 wherein determining whether a wireless bypass signature is indicated includes analyzing the signaling message traffic to identify calls originating or terminating with a SIM box.

3. The method of claim 1 wherein determining whether a wireless bypass signature is indicated includes analyzing the financial data to detect whether prepaid subscriptions are being recharged with a predetermined frequency.

4. The method of claim 1 wherein determining whether a wireless bypass signature is indicated includes analyzing the subscriber records to identify plural directory numbers corresponding to the same equipment identifier.

5. The method of claim 1 wherein performing a mitigating action comprises redirecting a mobile originating wireless bypass call to an interactive voice response unit controlled by a network operator seeking to detect wireless bypass events.

6. The method of claim 1 wherein performing a mitigating action comprises:
blocking call signaling messages associated with the wireless bypass event.

7. The method of claim 1 wherein performing a mitigating action comprises:
transmitting an alarm message to a network operations center.

8. The method of claim 1 wherein performing a mitigating action comprises:
routing the call to the intended called party at out-of-network rates.

9. The method of claim 1 wherein performing a mitigating action comprises:
transmitting at least one ping call to an originator of the wireless signaling message traffic.

10. A wireless bypass detection system (WBDS) for detecting a bypass traffic event, comprising:
a plurality of probes for copying wireless signaling message traffic traversing a wireless communications network; and
a bypass traffic event screening and mitigation module for:
(a) analyzing at least one of: (1) the wireless signaling message traffic, (2) financial information regarding wireless communications network subscriptions, and (3) subscriber records maintained in the wireless communications network,
(b) determining, based on the analysis, whether a wireless bypass signature is indicated; and
(c) (c) performing a mitigating action in response to determining that a wireless bypass signature is indicated.

11. The system of claim 10 wherein the bypass traffic event screening and mitigation module is configured to analyze the signaling message traffic to identify calls originating or terminating with a SIM box.

12. The system of claim 10 wherein the bypass traffic event screening and mitigation module is configured to analyze the financial data to detect whether prepaid subscriptions are being recharged with a predetermined frequency.

13. The system of claim 10 wherein the bypass traffic event screening and mitigation module is configured to analyze the subscriber records to identify plural directory numbers corresponding to the same equipment identifier.

14. The system of claim 10 wherein the bypass traffic event screening and mitigation module is configured to redirect a mobile originating wireless bypass call to an interactive voice response unit controlled by a network operator seeking to detect wireless bypass events.

15. The system of claim 10 wherein the bypass traffic event screening and mitigation module is configured to perform at least one of:
block call signaling messages associated with the wireless bypass event;
transmit an alarm message to a network operations center; and
route the call to the intended called party at out-of-network rates.

16. The system of claim 10 wherein the bypass traffic event screening and mitigation module is further adapted for transmitting at least one ping call to an originator of the wireless signaling message traffic.

17. A wireless bypass detection system (WBDS) for detecting a wireless bypass traffic event, comprising:
a signaling node including:
a plurality of communications modules for receiving wireless signaling message traffic traversing a wireless communications network; and
a wireless bypass traffic event screening and mitigation module for:
(a) analyzing at least one of: (1) the wireless signaling message traffic, (2) financial information regarding wireless communications network subscriptions, and (3) subscriber records maintained in the wireless communications network,
(b) determining, based on the analysis, whether a wireless bypass signature is indicated; and
(c) performing a mitigating action in response to determining that a wireless bypass signature is indicated.

18. The system of claim 17 wherein the bypass traffic event screening and mitigation module is configured to analyze the signaling message traffic to identify calls originating or terminating with a SIM box.

19. The system of claim 17 wherein the bypass traffic event screening and mitigation module is configured to analyze the financial data to detect whether prepaid subscriptions are being recharged with a predetermined frequency.

20. The system of claim 17 wherein the bypass traffic event screening and mitigation module is configured to analyze the subscriber records to identify plural directory numbers corresponding to the same equipment identifier.

21. The system of claim 17 wherein the bypass traffic event screening and mitigation module is configured to redirect a mobile originating wireless bypass call to an interactive voice response unit controlled by a network operator seeking to detect wireless bypass events.

22. The system of claim 17 wherein the bypass traffic event screening and mitigation module is configured to perform at least one of:
block call signaling messages associated with the wireless bypass event;
transmit an alarm message to a network operations center; and
route the call to the intended called party at out-of-network rates.

23. The system of claim 17 wherein the bypass traffic event screening and mitigation module is further adapted for transmitting at least one ping call to an originator of the wireless signaling message traffic.

24. A computer program product comprising computer executable instructions embodied in a tangible computer readable medium and when executed by a processor of a computer performs steps comprising:
(a) analyzing at least one of:
(i) wireless signaling message traffic in a wireless communications network;
(ii) financial information regarding wireless communications network subscriptions; and
(iii) subscriber records maintained in the wireless communications network;
(b) determining, based on the analysis, whether a wireless bypass signature is indicated; and
(c) in response to determining that a wireless bypass signature is indicated, performing a mitigating action.

25. The computer program product of claim 24 wherein determining whether a wireless bypass signature is indicated includes analyzing the signaling message traffic to identify calls originating or terminating with a SIM box.
